(19) United States
(12) Patent Application Publication
(10) Pub. No.: US 2008/0135703 A1
(43) Pub. Date: Jun. 12, 2008

(54) COUNTERTOP TEMPLATE TOOL

(76) Inventors: Douglas Andrew Craig, Sparks, NV (US); Sean Patrick Kelley, Reno, NV (US); Neil Richard Cahill, Sparks, NV (US)

Correspondence Address: HOLLAND & HART, LLP, P.O BOX 8749, DENVER, CO, 80201, US

(21) Appl. No.: 11/872,498

(22) Filed: Oct. 15, 2007

Related U.S. Application Data
(60) Provisional application No. 60/829,987, filed on Oct. 18, 2006.

(51) Int. Cl. F16B 2/22

(52) U.S. Cl. 248/229.16

(57) ABSTRACT

Described herein are several embodiments of a tool for use in making templates for countertops. For example, according to one embodiment, a countertop template clip includes a cabinet wall receiving portion and a template receiving portion. The cabinet wall receiving portion can be removably engaged with a cabinet wall. The template receiving portion is coupled to the cabinet wall receiving portion and can be removably engaged with a template piece. The cabinet wall receiving portion is removably engageable with a cabinet wall and the template receiving portion is removably engageable with a template piece such that the template piece is positionable to define a predetermined overhang relative to the cabinet wall.

### CROSS REFERENCE TO RELATED APPLICATION

This application claims the benefit of prior pending U.S. Provisional Application No. 60/829,987, filed Oct. 18, 2006, which is incorporated herein by reference.

### FIELD

The technology disclosed herein relates to tools for use in the fabrication of cabinet and countertop assemblies, and more particularly to tools for use in the construction of countertop templates.

### BACKGROUND

Countertops are placed over one or more cabinets to provide a working surface. Commonly, countertops, such as countertops made of natural stone, engineered stone, or solid surface materials, are fabricated using a countertop template or pattern. The countertop template typically is assembled directly over the physical cabinet on which the countertop will be mounted. At the discretion of the person creating the template, the outer periphery of the countertop template will represent either the outer periphery of the cabinet(s) or of the finished countertop. For the purposes of fabrication, the latter case is more desirable. Creating templates in this manner, however, can be prone to inaccuracies.

With conventional countertop and cabinet assemblies, the countertop may include portions that overhang an outer surface of the cabinet and may include portions that do not, or only minimally, overhang an outer surface of the cabinet. For example, the outer periphery of a countertop that does not border another object typically overhangs the cabinet. In contrast, the outer periphery of a countertop that borders an object, such as another countertop or fixed structure, e.g., a wall or appliance, typically does not overhang the cabinet. Accordingly, when constructing a template over the countertop, particular attention must be paid to the relative overhang between the template pieces and the cabinet walls so as to achieve an accurate countertop template.

Typically, countertop templates have been constructed by one or two methods. In the first method, each individual piece is positioned over the cabinet so that the outer edge of the piece is flush with the outer periphery of the cabinet. The pieces are then trimmed and adhered together. The assembled template is then along the appropriate edges in order to indicate the additional material that must be added for the desired overhang.

In the second method, countertop templates typically have been constructed by positioning each individual piece over the cabinet, measuring the overhang between the piece and the cabinet and comparing it to the desired overhang, re-positioning the piece and re-measuring the piece if necessary, and securing the piece in place without inadvertently moving the piece out of its proper position. Moreover, the above steps must be followed for each piece of the template, which can be quite laborious and time-consuming. Further, the more pieces that must be positioned, the greater the likelihood that the template may inaccurately represent the proper overhang or non-overhang of the desired countertop design. All pieces are then trimmed and adhered together.

Accordingly, there has been a need for reducing the excessive time, labor, and errors commonly associated with making a countertop template according to conventional methods.

### SUMMARY

Described herein are several embodiments of a tool for use in making templates for countertops. For example, according to one embodiment, a countertop template clip includes a cabinet wall receiving portion and a template receiving portion. The cabinet wall receiving portion is removably engageable with a cabinet wall. The template receiving portion is coupled to the cabinet wall receiving portion and removably engageable with a template piece. The cabinet wall receiving portion can be removably engaged with a cabinet wall and the template receiving portion can be removably engaged with a template piece such that the template piece is positionable to define a predetermined overhang relative to the cabinet wall.

According to some implementations of the template clip, the cabinet wall receiving portion can include a first relatively stationary or more rigid member and a first relatively more resiliently flexible member. The first resiliently flexible member can be movable relative to the first stationary member and spaced-apart from the first stationary member. A cabinet wall is positioned between the first stationary member and the first flexible member to removably engage the cabinet wall. In some aspects, the template clip also includes a base to which the cabinet wall receiving portion and the template receiving portion can be coupled. The template receiving portion can also include a second resiliently flexible member coupled to a second stationary member that extends from the base. The template piece can be positioned between the second resiliently flexible member and the base to removably engage the template piece. In some instances, the distance between the first stationary member and the second stationary member is approximately equal to the length of the predetermined overhang. In other instances, the distance between the first stationary member and the second stationary member, minus the thickness of cabinet wall, is approximately equal to the length of the predetermined overhang. In specific instances, the length of the predetermined overhang is approximately zero.

In some implementations, the template clip also includes a base. The cabinet wall receiving portion can extend from the base in a first direction and the template receiving portion can extend from the base in a second direction generally opposite the first direction. According to certain aspects of the template clip, the cabinet wall receiving portion includes a relatively flexible arm that has a first end attached to the base and a second end spaced apart from the base. The flexible arm can extend away from the base from the first end to an intermediate portion positioned between the first end and a second end of the arm. The arm can extend back toward the base from the intermediate portion to the second end. In certain implementations, the flexible arm is substantially V-shaped.

In specific implementations, the clip further includes an electronic template target element removably coupled to the template receiving portion.

According to a second embodiment, a countertop template clip for positioning a template piece relative to a cabinet wall includes a base, cabinet wall securing portion and template securing portion. The base extends from a first end portion to a second end portion. The cabinet wall securing portion is coupled to the base and includes a resiliently flexible first arm and a second arm. The resiliently flexible first arm includes a first portion that is attached to and extends away from the base and a second portion that extends from the first portion toward the first end portion of the base. The second arm extends approximately parallel to the first portion of the first arm and away from the base at a location between the second portion of the first arm and the first end portion of the base. The template securing portion is coupled to the base and includes a resiliently flexible third arm. The resiliently flexible third arm includes (i) a first portion that is attached to and extends away from the base in a direction substantially opposite the first portion of the first arm, and (ii) a second portion that extends from the first portion toward the second end portion of the base.

According to some implementations, the base and template securing portion cooperatively provide a substantially arcuate clip. In certain implementations, the first arm, second arm, and base cooperatively form an internally spring-biased clip.

In some implementations of the clip, the second arm of the cabinet wall securing portion is intermediate the resiliently flexible first arm and the first portion of the resiliently flexible third arm.

In yet some implementations, a distance between the second arm of the cabinet wall securing portion and the first portion of the resiliently flexible third arm is approximately equal to a predetermined overhang of the template piece relative to the cabinet wall. The predetermined overhang can be zero or greater than zero.

According to some aspects, the resiliently flexible first arm is movable away from the second arm to removably secure a cabinet wall between the first arm and the second arm. The resiliently flexible second arm is movable away from the base to removably secure a template piece between the first arm and the base. In certain implementations, the cabinet wall has an outer surface and an inner surface. Moreover, when removably secured between first arm and the second arm, the first arm is in contact with the inner surface and the second arm is in contact with the outer surface.

In some implementations of the clip, a minimum distance between the second portion of the first arm and the second arm is less than a thickness of the cabinet wall. Further, a minimum distance between the second portion of the third arm and the base is less than a thickness of the template piece.

According to a third embodiment, an electronic countertop template clip includes a cabinet wall receiving portion that is removably engageable with a cabinet wall and an electronic countertop template target portion that is coupled to the cabinet wall receiving portion. When the cabinet wall receiving portion is removably engaged with a cabinet wall, a target of the target portion is positioned at a predetermined overhang distance away from an outer surface of the cabinet wall.

According to one exemplary embodiment, a method of positioning a countertop template piece at a desired overhang relative to a cabinet wall includes providing a countertop template tool that includes a cabinet wall receiving portion and a template piece receiving portion. The cabinet wall receiving portion includes a first resiliently flexible member and a first stop. The template piece receiving portion includes a second resiliently flexible member and a second stop. The first stop and second stop are a predetermined distance apart. The method further includes removably securing a cabinet wall within the cabinet wall receiving portion by resiliently flexing the first resiliently flexible member with the cabinet wall. The method also includes removably securing a template piece within the template piece receiving portion by resiliently flexing the second resiliently flexible member with the template piece. Additionally, the method includes positioning the cabinet wall in contact with the first stop and positioning an outer edge of the template piece in contact with the second stop.

According to some aspects, the predetermined distance can be equal to the desired overhang. In other aspects, the predetermined distance can be greater than the desired overhang. In some implementations, the predetermined distance minus a thickness of the cabinet wall is equal to the desired overhang.

In various aspects, the first resiliently flexible member applies a biasing force to the cabinet wall to removably secure the cabinet wall within the cabinet wall receiving portion. Also, the second resiliently flexible member can apply a biasing force to the template piece to removably secure the template piece within the template piece receiving portion.

According to some embodiments, the countertop template clip is relatively small, lightweight, portable, and inexpensive. For example, the clip can be small enough such that a plurality, e.g., a handful, of clips can be stored in a shirt or pant pocket of a user. Further, the clips can be made of a lightweight and inexpensive material, such as plastic, and mass produced using inexpensive fabrication techniques, such as injection molding techniques.

It is to be understood that the above Summary recites certain aspects of embodiments of the invention, but no embodiment need include all such aspects, nor such aspects as stated, nor need an embodiment necessarily address any issues noted in the background above. The foregoing and other features and advantages of the disclosed tools will become more apparent from the following detailed description, which proceeds with reference to the accompanying figures.

### BRIEF DESCRIPTION OF THE DRAWINGS

The preferred and other embodiments are shown in the accompanying drawings wherein:

FIG. 1 is a perspective view of cabinets with respective countertop templates secured to the cabinets by template tools.

FIG. 2 is a partial exploded perspective view of the cabinets, templates and template tools of FIG. 1 shown with some template pieces and template tools detached from the cabinet system.

FIG. 3 is a detailed partial exploded perspective view of a cabinet, template pieces and template tools of FIG. 2.

FIG. 4 is a perspective view of a template clip according to a first embodiment.

FIG. 5 is an elevation side view of the template clip of FIG. 4.

FIG. 6 is an elevation side view of the template clip of FIG. 4 shown removably secured to a cabinet wall and template piece.

FIG. 7 is a perspective view of a template clip according to a second embodiment.

FIG. 8 is an elevation side view of the template clip of FIG. 7.

FIG. 9 is an elevation side view of the template clip of FIG. 7 shown removably secured to a cabinet wall and template piece.

FIG. 10 is an elevation side view of a template clip according to a third embodiment.

FIG. 11 is an elevation side view of a template clip according to a fourth embodiment.

FIG. 12 is a perspective view of a template clip according to a fifth embodiment.

FIG. 13 is an elevation side view of the template clip of FIG. 12.

FIG. 14 is an elevation side view of a template clip according to a sixth embodiment.

FIG. 15 is a perspective view of a template clip according to a seventh embodiment.

FIG. 16 is a perspective view of an electronic target element according to one exemplary embodiment.

### DETAILED DESCRIPTION

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

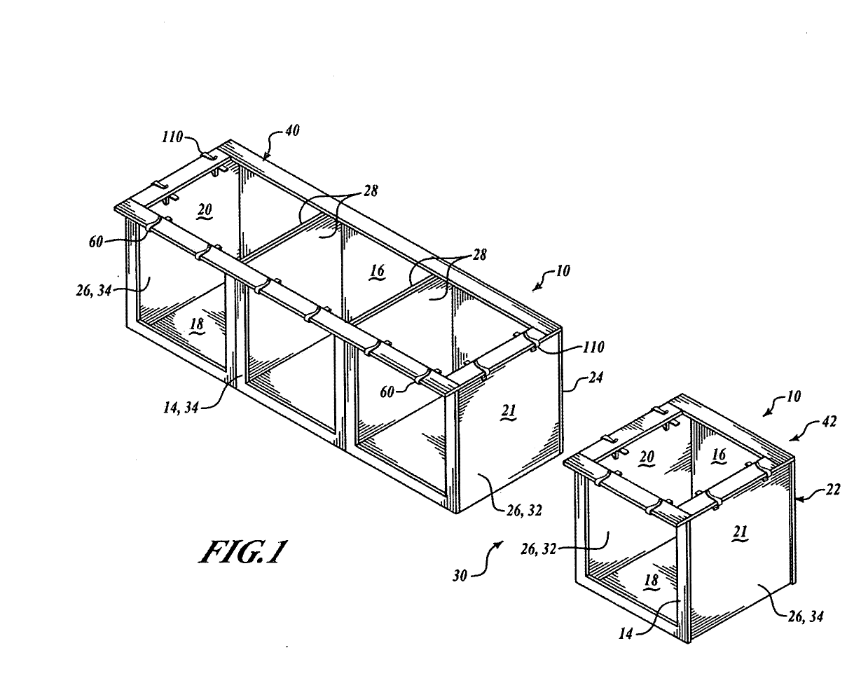

Described herein are several embodiments of a tool for use in making templates for countertops. Countertops are supported by and attached to one or more cabinets or cabinet assemblies. Referring to FIGS. 1-3, some conventional cabinets, such as cabinets 10, each include a front wall 14 opposite a back wall 16, bottom wall 18, left side wall 20 and right side wall 21 opposing the left side wall. In use, each cabinet 10 can act as a stand-alone, unitary cabinet, such as unitary cabinet 22, or combined with one or more other cabinets to form a cabinet assembly, such as cabinet assembly 24. In a typical kitchen application, at least one cabinet is spaced-apart from another cabinet to define an appliance receiving space. For example, the unitary cabinet 22 is spaced-apart from the cabinet assembly 24 such that an appliance receiving space 30 is defined between the cabinet and cabinet assembly. As is typical, the left side wall 20 of the unitary cabinet 22 and the right side wall 21 of the cabinet assembly 24 are adjacent the appliance receiving space 30 and considered non-overhang walls 32 because they support a non-overhanging portion of the countertop. In the illustrated embodiment, the right side wall 21 of the unitary cabinet 22 and the left side wall 20 of the cabinet assembly 24 are considered overhang walls 34 because they support an overhanging portion of the countertop. Further, the front walls 14 are considered overhang walls 34 in most instances, and the back walls 16 can be overhang walls 34 or non-overhang walls 32 depending on the application or cabinet layout.

Each wall has a thickness t defined between an outer facing surface 35 and an inner facing surface 36 (see FIG. 6). Moreover, the walls each include a top end 37 and a bottom end 38. The top end 37 extends about a periphery of the cabinet and defines a countertop support surface 39. A countertop (not shown) is positioned on and attached to the countertop support surface 39. Conventionally, the countertop has the same or similar peripheral shape as the peripheral shape of the respective cabinet or cabinet assembly. Additionally, the countertop is configured to be approximately flush with the outer facing surface 35 of the non-overhang walls 32 and extend outwardly beyond the overhang walls 34 a predetermined distance, as will be described in more detail below.

As described above, the countertop is made by first constructing a countertop template, such as template 40 for cabinet assembly 24 and template 42 for unitary cabinet 22 (see FIG. 1). In the exemplary embodiment, each template 40, 42 includes four separate elongate pieces of template material 44. The template pieces 44 can be made from any of various materials and have any of various dimensions. For example, in some implementations, the template pieces are made from wood and have a thickness between approximately 0.03 inches and approximately 0.1875 inches. Other examples of materials from which the template 44 can be constructed include plastic sheet or strips, cardboard, thick paper, etc. Each piece 44 includes a first end portion 46 and a second end portion 48 generally opposite the first end portion. Each first end portion 46 is coupled to the second end portion 48 of an adjacent piece 44. Further, in the case of rectangular cabinets or cabinet assemblies, each piece 44 extends perpendicularly relative to the adjacent two pieces to form a rectangle. For example, the template piece 44 supported by the front wall 14 is a front piece 50, the template piece supported by the overhang side wall 34 is a left piece 52, the template piece supported by the non-overhang side wall 32 is a right piece 54, and the template piece supported by the back wall 16 is a back piece 56.

Prior to coupling to each other, the pieces 44 are removably secured to the walls of the cabinets via tools 60, 110. The tools 60, 110 facilitate proper positioning of the pieces 44 relative to the walls of the cabinets and each other as will be described in more detail below. Once the pieces 44 are properly positioned and secured to the walls through use of the tools 58, the first and second end portions can be coupled together to form the template 40. The template 40 can then be removed from the cabinets and the tools 60, 110 can be removed from the template 40. As described above, the template 40 is then used as a guide or pattern for making the counter top.

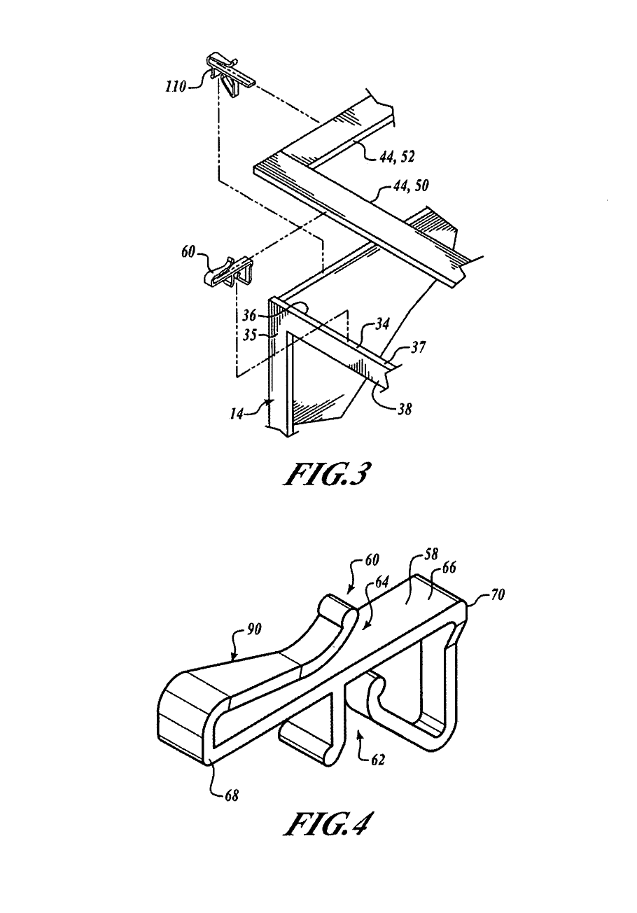

Referring to FIGS. 4 and 5, and according to a first embodiment, at least some of the tools 60 are clips 58 having a wall receiving portion 62 and a template receiving portion 64. The wall receiving portion 62 and the template receiving portion 64 are coupled together via a base 66 extending from a first end 68 to a second end 70 opposite the first end.

The wall receiving portion 62 includes a first flexible arm 72 having a generally V-shaped or U-shaped profile. The first flexible arm 72 includes a first portion 74 and a second portion 76. The first portion 74 extends substantially perpendicularly away from the base 66 at a location proximate the second end 70. The second portion 76 extends from the first portion 74 at a location spaced-apart from the base 66 and extends at an angle relative to the first portion toward the base and the first end 68. The second portion 76 terminates at a wall contact end portion 78 spaced apart from the base 66. The wall receiving portion 62 also includes a second arm, e.g., stop or register, 80 that extends substantially perpendicularly away from the base 66 (i) in substantially the same direction as the first portion 74 of the first flexible arm 72 and (ii) at a location intermediate the first portion 74 and the first end 68 of the base. The length of the second arm 80 can be any of various lengths, such as to accommodate, e.g., not interfere with, false drawer fronts or other features on the outer surface 35 of the cabinet walls. In some implementations, the first flexible arm 72 has a thickness that is smaller than the thickness of the second arm 80. Accordingly, the second arm 80 is substantially more rigid than the first flexible arm 72. The wall receiving portion 62 includes a wall receiving space 82 defined between the wall contact end portion 78 and the second arm 80. The first flexible arm 72, second arm 80, and base 66 cooperatively form an internally spring-biased wall clip.

The first flexible arm 72 is biased in a first position such that the length L1 of the space 62 is smaller than the thickness t of a cabinet wall to which the clip 60 is to be attached (see FIG. 5). The wall contact end portion 78 is movable away from the second portion 80 by applying a pressure sufficient to overcome the bias of the arm to flex the first flexible arm 72 substantially at the intersection of the first and second portions 74, 76, respectively. For example, such as an overhang wall 34, can be inserted into the space 82 with sufficient force to overcome the bias of the first flexible arm 72, move the wall contact end portion 78 away from the second arm 80 and place the first flexible arm into a second position (see FIG. 6). Because the first flexible arm 72 is biased in the first position, the first flexible arm 72 applies a retaining force against the overhang wall 34 to at least partially retain the wall against the second arm 80 and within the space 82. In the illustrated implementation, to facilitate insertion of a cabinet wall into the space 82, the wall contact end portion 78 is rounded and the second arm includes an outwardly angled flange portion 84. The outwardly angled flange portion 84 can assist in guiding a cabinet wall into engagement with the wall receiving portion 62 as will be described in more detail below. Moreover, the upwardly angled nature of the second portion 76 of the first flexible arm 72 can also assist in guiding a cabinet wall into engagement with the wall receiving portion 62.

The template receiving portion 64 includes a second flexible arm 90 that includes a first portion 92 and a second portion 94. The first portion, e.g., stop, 92 extends approximately perpendicularly from the base 66 at a location proximate the first end 68 of the base and in a direction generally opposite the direction of the first portion 74 of the first flexible arm 72. The first portion 92 is relatively rigid compared to the second portion 94. The second portion 94 extends from the first portion 92 in a direction substantially toward the second end 70 of the base 66. As shown, in some implementations, the second portion 94 can also extend downwardly away from the first portion 92 toward the base 66. As shown, the second portion 94 can be substantially linear and the intersection or elbow between the first and second portions can be curved to facilitate flexing of the second flexible arm 90. Alternatively, the second portion 94 can include one or more curved sections as desired.

The second portion 94 terminates at a template contact end portion 96 in contact with or spaced-apart from the base 66. As illustrated, the template contact end portion 96 can include a substantially curved or arcuate section such that the second flexible arm 90 and the base 66 cooperatively form an arcuate clip. The template contact end portion 96 can include a curved section that extends toward the base 66 and a curved section that extends away from the base.

Further, in some implementations, the second portion 94 is tapered in a direction extending toward the second end 70 of the base 66. The template receiving portion 64 also includes a template receiving space 98 defined between the template contact end portion 96 and the base 66. As a template piece is inserted into the space 98, the curved section extending away from the base can contact the template piece to facilitate insertion of the template piece into the space. The second flexible arm 90 and base 66 cooperatively form an internally spring-biased template piece clip.

The second flexible arm 90 is biased in a first position such that the length L2 of the space 98 is smaller than the thickness t of the template piece 44 that is removably secured within the space 98 (see FIG. 6). Similar to the wall receiving portion 62, the template contact end portion 96 is movable away from the base 66 by applying a pressure sufficient to overcome the bias of the arm 90 to flex the second flexible arm substantially at the intersection of the first and second portions 92, 94, respectively. For example, as shown in FIG. 6, a template piece 44 can be inserted into the space 98 with sufficient force to overcome the bias of the second flexible arm 90, move the template contact end portion 96 away from the base 66 and place the second flexible arm into a second position. Because the second flexible arm 90 is biased in the first position, the second flexible arm applies a retaining force against the template piece 44 to at least partially retain the piece against the base 66 and within the space 98. In the illustrated implementation, to facilitate insertion of a template piece 44 into the space 98, the template contact end portion 96 is at least partially curved with a portion extending away from the base 66.

In some implementations, the free ends of the first flexible arm 72 and the free end of the second flexible arm 90 include bulbous portions.

The clip 60 is configured to properly position a template piece 44 representing an overhanging portion of the countertop relative to an overhang wall 34. Referring to FIG. 6, the overhang wall 34, e.g., the front wall 14 and the left side wall 20 of the cabinet assembly 24, is properly inserted within the space 82 when the support surface 39 of the wall contacts the base 66 and the outer surface 35 of the wall is pressed against an inner surface 100 of the second arm 80. Similarly, the template piece 44 is properly inserted within the space 98 when an outer edge 102 of the template piece is in contact with an inner surface 104 of the first portion 92 of the second flexible arm 90. The inner surface 100 of the second arm 80, which acts as a cabinet wall registration surface, is offset from the inner surface 104 of the first portion 92 of the second flexible arm 90, which acts as a template piece registration surface, a predetermined distance D_{OFFSET}. Accordingly, when the overhang wall 34 and template piece 44 are properly inserted into the respective spaces 82, 98, as shown in FIG. 6, the outer edge 102 of the template piece is offset from the outer surface 35 of the overhang wall 34 the same distance D_{OFFSET}. In other words, when properly secured to the clip 60, the template piece 44 overhangs the overhang wall 34 by the distance D_{OFFSET}.

The predetermined distance D_{OFFSET} represents the desired offset of the finished countertop relative to the cabinet wall. Accordingly, the clip 60 can be configured such that the distance D_{OFFSET} is equal to the desired offset of the finished countertop.

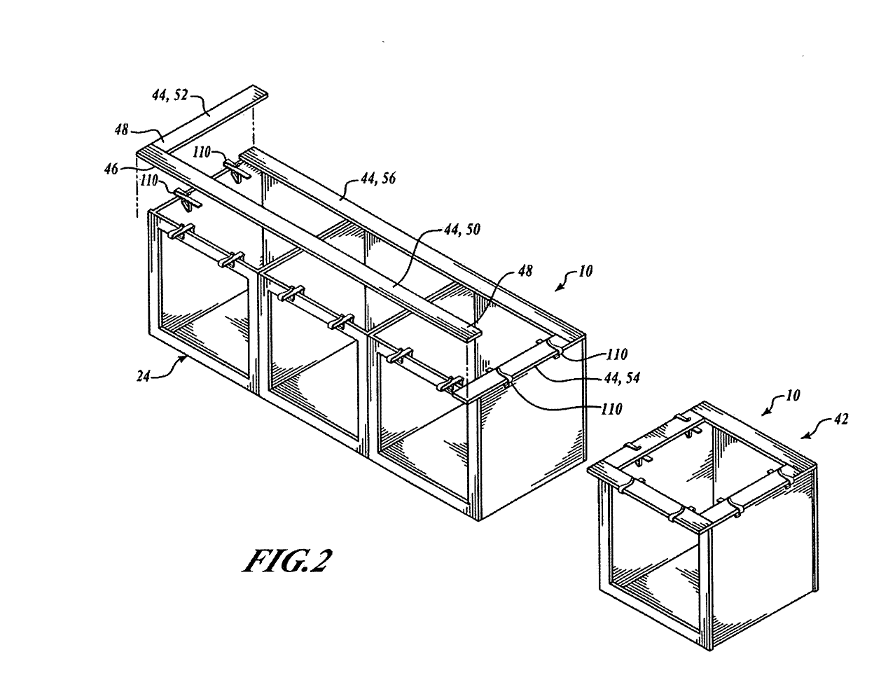

When constructing a template 40 of a countertop that includes one or more edges that are designed to overhang the cabinet walls, the clip 60 can be used to accurately and consistently position a template piece relative to an overhang wall to achieve the desired overhang distance of the finished countertop. As shown in FIG. 2, a plurality of clips 60 can be removably secured to and spaced-apart along the front wall 14 of the cabinet assembly 24 as described above. The front template piece 50 has a length substantially equal to the desired length of the front of a finished rectangular countertop and is then properly inserted into the respective spaces 82 of each of the clips 60 secured to the front wall 14. In this manner, the front template piece 50 overhangs the front wall 14 by the predetermined distance D_{OFFSET} along the entire length of the template piece without measuring, tacking, or adjusting of the template piece.

With the front template piece 50 properly positioned relative to the front wall 14, another template piece, such as the left piece 52, can be properly positioned relative to the front template piece and the overhang side wall 34. For example, as shown in FIGS. 1 and 2, one or more spaced-apart clips 60 can be secured to the overhang side wall 34. A template piece 44 having a length equal to the desired width of the finished rectangular countertop is then positioned over the front template piece 50 and properly inserted into the respective spaces 82 of each of the several clips 60 secured to the overhang side wall 34. The overlapping end portions of the template pieces 44 can then be secured together using any of various known fastening devices, such as nails, studs, staples, etc. Alternatively, a bonding material can be applied to one or both of the overlapping portions prior to secure the front template piece 50 to, for example, the left template piece 52. Once the front and left template pieces 50, 52 are properly positioned using the clips 60, the overlapping portions are pressed together and the bonding material, being between the overlapping portions, bonds the pieces together.

Any remaining overhang template pieces can be properly positioned relative to other overhang template pieces and the cabinet using clips 60 in the same manner as described above. For example, the back wall 16 of cabinet assembly 24 may be an overhang wall 34, such as when the cabinet assembly functions as a kitchen island. The back piece 56 of the template 40 could be properly positioned relative to the left piece 52 and the back wall 16 by using the clips 60. However, in some instances, the back wall 16 of cabinet assembly 24, and thus the countertop, could abut a stationary structural object, such as the wall of a house. In these instances, the back piece 56 of the template does not overhang the back wall 16. Rather, to provide an accurate template of the countertop, the back piece 56 would also abut the stationary object. Accordingly, the stationary object, e.g., wall, provides a guide for accurately positioning the back piece 56 relative to the other template pieces and the back wall 16. Similarly, in some instances, the left side wall 20 abuts a stationary object, which can act as a guide for the left piece 52 such that the left piece can be positioned without the clips 60.

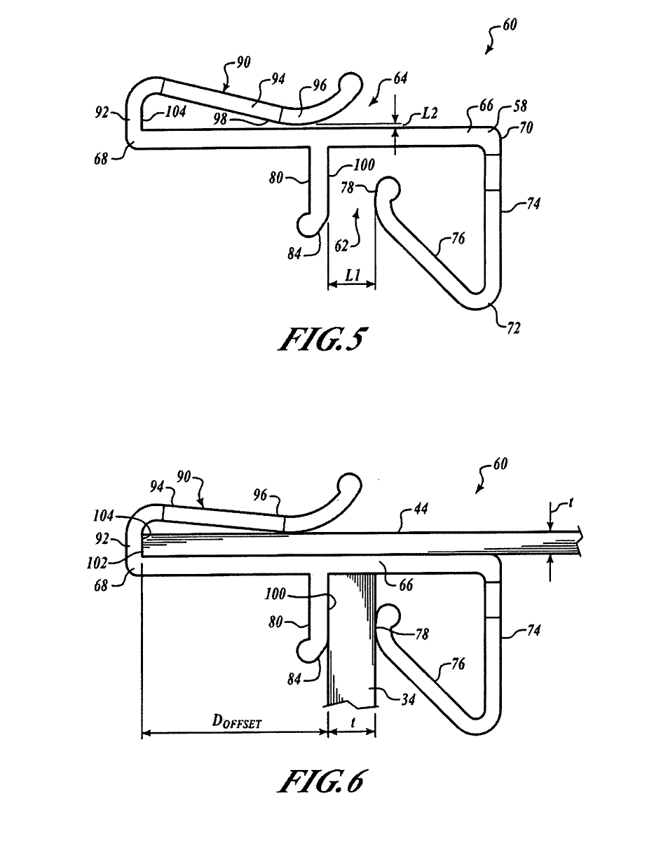

According to some embodiments, at least some of the tools 58 are clips similar to clip 60, but used for templating the portions of the countertop that do not substantially overhang the cabinet walls, such as adjacent an appliance space. For example, in the illustrated embodiment shown in FIGS. 7-9, the right piece 54 of the cabinet assembly 24 can be properly positioned relative to the right side wall 21 of the cabinet assembly, e.g., right side non-overhang wall 32, through use of a clip 110. The clip 110 includes the same general features of the clip 60 and thus the general details of clip 110 will be understood with reference to the clip 60 as described above. However, the clip 110 includes several differences over the clip 60 as noted below.

Like the clip 60, the clip 110 includes a base 112 to which a wall receiving portion 114 and a template receiving portion 116 are coupled. The wall receiving portion 114 includes a first flexible arm 118 and a second arm 120 having the same general configuration as the first flexible arm 72 and second arm 80 of the clip 60. The template receiving portion 116 includes a second flexible arm 122 having first and second portions 124, 126 with the same general configuration as the second flexible arm 90 of the clip 60. However, the distance D_{OFFSET} between the second arm 120 of the first flexible arm 118 and the first portion 124 of the second flexible arm 122 is substantially smaller than the distance D_{OFFSET} between the second arm 80 and the first portion 92 of the clip 60. Further, because the distance D_{OFFSET} is smaller, the base 112 is shorter than the base 66.

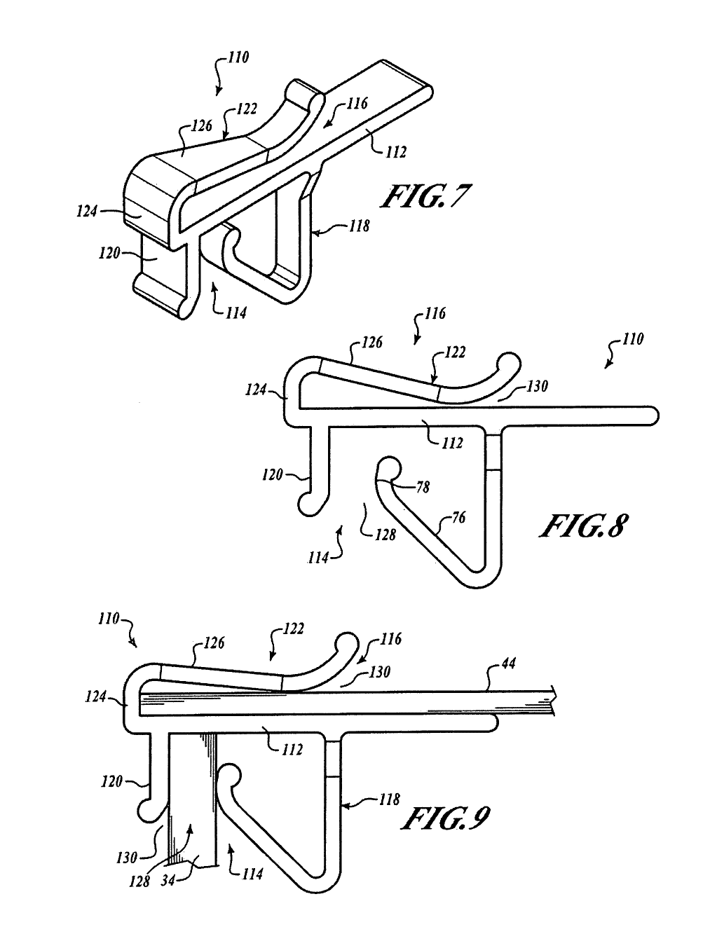

The clip 110 is configured to properly position a template piece 44 representing a non-overhanging portion of a countertop relative to a non-overhang wall 32. Referring to FIG. 9, the non-overhang wall 32, e.g., the left side wall 20 of unitary cabinet 22 and the right side wall 21 of the cabinet assembly 24, is properly inserted and retained within a space 128 between the first flexible arm 118 and second arm 120 as described above. Further, the template piece 44 is properly inserted and retained within a space 130 between the second flexible arm 122 and the base 112. In some implementations, such as shown, when properly retained by the clip 110, the outer edge 102 of template piece 44 is offset a distance so that it will be nearly coplanar with the edge of the front wall that is adjacent and parallel to the non-overhang wall.32.

When constructing a template 40 of a countertop that includes one or more edges that are designed to sit flush with or minimally overhang a cabinet wall, the clip 110 can be used to accurately and consistently position a template piece relative to a non-overhang wall. For example, as shown in FIG. 2, clips 110 can be removably secured to and spaced-apart along the right side wall 21 of cabinet assembly 24. The right piece 54 can have a length substantially equal to the desired length of the right side of the finished rectangular countertop and be inserted into the spaces 128 of each clip 110. The right piece 54 can overlap or be overlapped by the front piece 50 and the back piece 56 and secured to front and back piece in a manner as described above.

Further, the template pieces 50, 52, 54, 56 can be secured to each other as described above to complete the template 40. After the template 40 is completed, it can be lifted from the cabinet assembly 24. Because the clips 60, 110 are secured to the template 40, the clips also are lifted and removed from the cabinet assembly 24 along with the template. Once the template 40 is removed from the cabinet assembly 24, the clips 60, 110 are then removed from the template 40 by pulling them out of engagement with the template receiving portions 64 of the clips 60. The template 40 can then be used as a pattern for the manufacture of one or more countertops. Also, the clips 60, 110 can be reused to construct other templates using the same or different cabinet assemblies. Although not specifically described, the template 42 of the unitary cabinet 22 can be constructed in a manner similar to that described above for template 40.

Although the illustrated embodiment is described in relation to a generally square or rectangular shaped template and countertop, the same principles and features can be applied to construct templates having any of various other standard or custom shapes.

The distance D_{OFFSET} of the clips 60, 110 can be varied according to the desired offset of the countertop relative to the cabinets. The desired offset can depend on any of various factors, such as, for example, the relative locations of surrounding structures, and the layout of the cabinets. Moreover, as the desired offset may vary from one portion to another portion of the finished countertop, the assembly of one template may require any number of clips 60 having any number of D_{OFFSET} values.

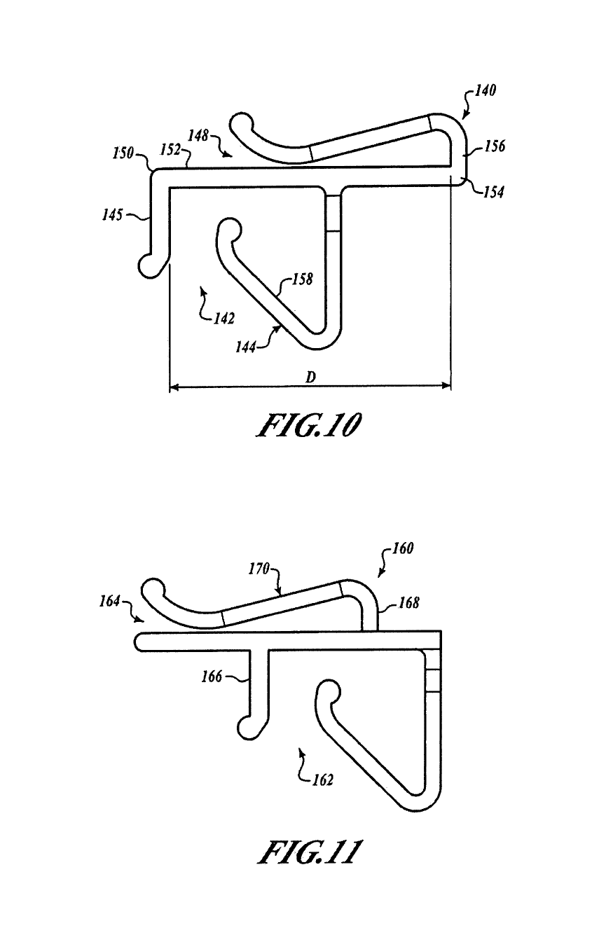

According to a second embodiment, a clip 140 somewhat similar to clip 60 can be used for templating portions of a countertop that overhang the cabinet walls (see FIG. 10) and a clip 180 similar to clip 110 can be used for templating portions of a countertop that do not substantially overhang the cabinet walls (see FIG. 11). Like the clip 60, the clip 140 includes a wall receiving portion 142 with a first flexible arm 144 and a second arm 145, and a template receiving portion 146 with a second flexible arm 148. However, the orientation of the template receiving portion 146 relative to the wall receiving portion 142 is reversed compared to wall and template receiving portions 62, 64 of clip 60. More specifically, instead of extending from a first end 150 of base 152 toward a second end 154 of the base, the second flexible arm 148 extends from the second end of the base toward the first end. The wall receiving portion 142 remains substantially unchanged. In other words, the first flexible arm 144 extends perpendicularly from the base 152 and bends to extend in a direction toward the first end 150 of the base.

An overhang wall 34 is removably secured and properly positioned by the wall receiving portion 142 much like the wall receiving portion 62, and a template piece 44 is removably secured and properly positioned by the template receiving portion 144 much like the template receiving portion 64. However, instead of the first flexible arm contacting an inner surface 36 of an overhang wall 34 and the second arm contacting an outer surface 35 of the overhang wall, the first flexible arm 144 contacts the outer surface of the overhang wall and the second arm 145 contacts the inner surface of the overhang wall. Accordingly, the amount of overhang is determined by the distance D between the second arm 145 and a first portion 156 of the second flexible arm 148 minus the thickness of the overhang wall 34.

Referring to FIG. 11, alternatively a clip 160 somewhat similar to clip 140, but configured to removably receive a template piece representing a non-overhanging portion of the finished countertop. Generally, the wall receiving portion 162 and the template receiving portion 164 are shifted such that the second arm 166 of the wall receiving portion 162 and the first portion 168 of the second flexible arm 170 of the template receiving portion 164 are closer together. In this manner, the overhang of the template piece 44 relative to the non-overhang wall 32 can be reduced, and if desired, eliminated completely.

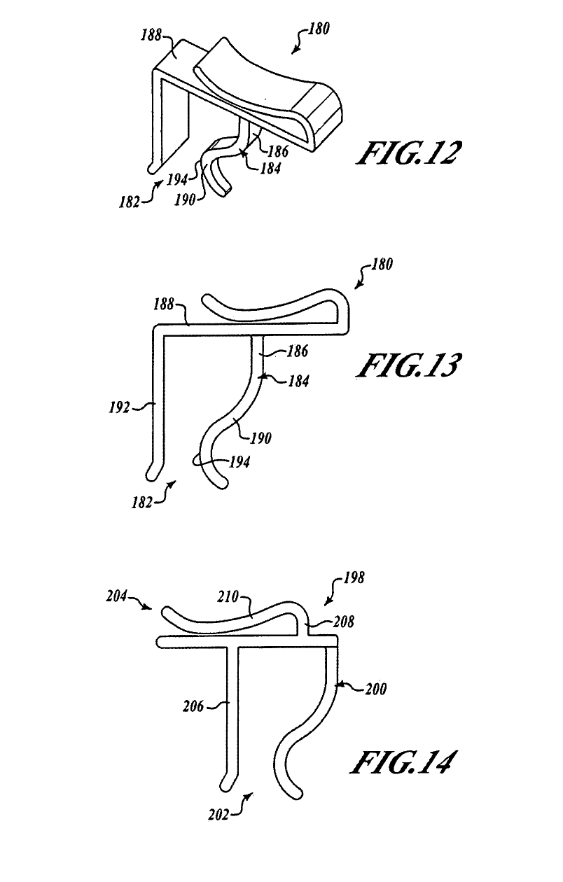

According to yet another embodiment, a clip 180 similar to clip 140 can be used for templating portions of a countertop that overhang the cabinet walls (see FIGS. 12 and 13). The clip 180 includes the same general features of the clip 140 and thus the general details of clip 180 will be understood with reference to the clip 140 as described above. However, the clip 180 includes several differences over the clip 140 as noted hereafter. For example, the wall receiving portion 182 of clip 180 includes a first flexible arm 184 that is configured differently than the first flexible arms 144 of the clip 140.

The first flexible arm 184 of clip 180 has a first portion 186 that extends substantially perpendicularly from a base 188 and a second portion 190 that extends toward a second arm 192. Like the second portion 76 of the first flexible arm 72, the second portion 190 includes a curved wall contact end portion 194. Also, the first flexible arm 184 is biased in a first position, as shown in FIG. 13, and configured to resiliently flex into a second position upon application of a pressure sufficient to overcome the biasing force. However, rather than extending upwardly toward the base 188 from the first portion 186 as with second portion 158 of clip 140, the second portion 190 of clip 180 continues to extend downwardly away from the base. Accordingly, instead of having a generally U-shaped or V-shaped profile like first flexible arm 144, the first flexible arm 184 has a generally S-shaped profile.

Referring to FIG. 14, a clip 198 similar to clip 180, but configured to removably receive a template piece representing a non-overhanging portion of the finished countertop. For example, the first flexible arm 200 of the wall receiving portion 202 of the clip 198 is substantially the same as the first flexible arm 184 of the clip 180. However, the wall receiving portion 202 and the template receiving portion 204 are shifted such that the second arm 206 of the wall receiving portion 202 and the first portion 208 of the second flexible arm 210 of the template receiving portion 204 are closer together. In this manner, the overhang of the template piece 44 relative to the non-overhang wall 32 can be reduced, and if desired, eliminated completely.

The above embodiments describe clips for constructing physical countertop templates. In some embodiments, the clips described herein can be used for obtaining electronic countertop templates, which are used by computer aided drafting software applications in the manual or CNC manufacturing of countertops.

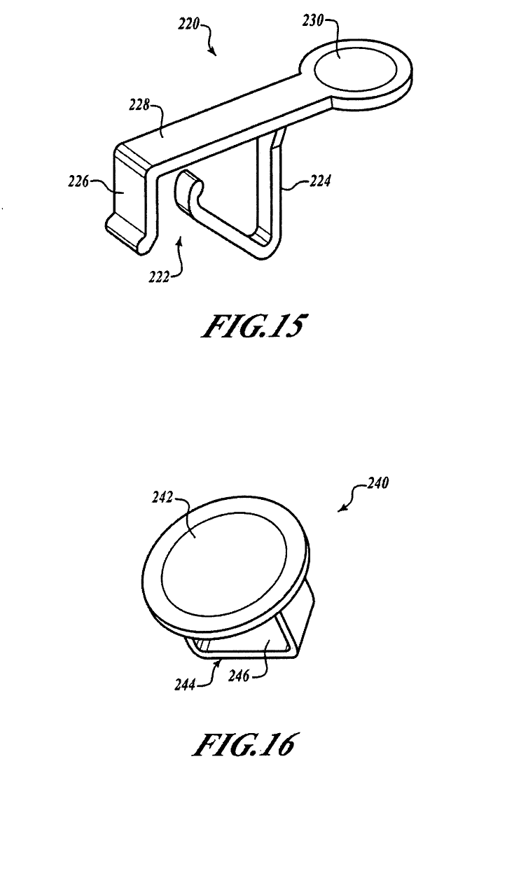

For example, in one implementation, clip 220 includes a wall receiving portion 222 having a first flexible arm 224 and a second arm 226 coupled to a base 228 (see FIG. 15). The wall receiving portion 222 is similar to the wall receiving portion 142 of the clip 140 and removably secures a cabinet wall in the same manner as described above for the wall receiving portion 142. However, instead of a template receiving portion, the clip 220 includes a target 230 coupled to the base 228 at a predetermined distance away from the second arm 226. The position of the target 230 with respect to the second arm 226 is dependent upon the desired amount of countertop overhang. For example, as shown in FIG. 15, the target 230 is centered at a location substantially offset from the wall receiving portion 142 to represent a desired overhang of the countertop relative to the cabinet wall. As described above, the amount of overhang is equal to the predetermined distance between the second arm 226 and the center of the target 230 minus the thickness of the cabinet wall.

Although not shown, the target 230 can be positioned closer to the second arm 226 to decrease, or eliminate, the offset of the target 230 with respect to the wall receiving portion 142 such that the clip can represent a desired minimal or lack of overhang of the countertop relative to the cabinet wall. Additionally, although not shown, in some implementations, the orientation of the wall receiving portion 222 of the clip 220 is reversed to closely resemble the configuration of clip 60. In other words, the second arm 226 can be intermediate the target 230 and the first flexible arm 224 rather than the first flexible arm being intermediate the target and the second arm.

Alternatively, a clip for constructing physical countertop templates, such as clips 60, 110, 140, 160, 180, 198, can be used for obtaining an electronic countertop template by attaching a removable target element 240 (see FIG. 16). The target element 240 includes a target 242 coupled to, e.g., formed integrally with, a clip receiving portion 244 defining an opening 246. The target element 240 can be removably secured to a clip by inserting the second flexible arm of the clip through the opening 246 and into contact with the first portion of the second flexible arm. In this manner, the target is centered at the same approximate location of the outer edge of a template piece when properly secured to the clip. In this manner, a clip for constructing physical countertop templates can be retrofitted for obtaining electronic countertop templates.

In use, one or more clips 220 for modeling an overhang portion of the countertop, one or more clips 220 for modeling a non-overhang portion of the countertop, or one or more clips 60, 110, 140, 160, 180, 198 retrofitted with target element 240 are removably secured to the cabinet walls. Multiple digital photographs of the clip layout from various locations and angles are processed by a CAD software application, such as Integration Module manufactured by ETemplate of Raleigh, N.C., to convert the target locations into a CAD-based electronic template. As described above, the electronic template can be used to fabricate a countertop either manually or with CNC equipment.

In some embodiments, the clips 60, 110, 140, 160, 180, 198, 220 and target element 240 are preferably made of a unitary, one-piece construction. Further, in certain embodiments the clips and target element are preferably made of a polymer material, such as plastic, but can also be made of any of various other flexible materials, such as, but not limited to a metal, e.g., aluminum, spring steel, fiberglass, and epoxy based resins. Also, the clips 60, 110 can be made using any of various known manufacturing techniques, such as, but not limited to, casting, forging, injection molding, machining, stamping, forming, etc.

In view of the many possible embodiments to which the principles of the disclosed tool may be applied, it should be recognized that the illustrated embodiments are only preferred examples and should not be taken as limiting the scope of the invention. Rather, the scope of the invention is defined by the following claims. We therefore claim as our invention all that comes within the scope and spirit of these claims.

We claim:

1. A countertop template clip, comprising:
a cabinet wall receiving portion removably engageable with a cabinet wall; and
a template receiving portion coupled to the cabinet wall receiving portion and removably engageable with a template piece;
wherein the cabinet wall receiving portion can be removably engaged with a cabinet wall and the template receiving portion can be removably engaged with a template piece such that the template piece is positionable to define a predetermined overhang relative to the cabinet wall.

2. The clip of claim 1, wherein the cabinet wall receiving portion comprises a first stationary member and a first resiliently flexible member movable relative to the first stationary member and spaced-apart from the first stationary member, and wherein the cabinet wall is positionable between the first stationary member and the first flexible member to removably engage the cabinet wall.

3. The clip of claim 2, further comprising a base to which the cabinet wall receiving portion and the template receiving portion are coupled, wherein the template receiving portion comprises a second resiliently flexible member coupled to a second stationary member extending from the base, and wherein the template piece is positionable between the second resiliently flexible member and the base to removably engage the template piece.

4. The clip of claim 3, wherein the distance between the first stationary member and the second stationary member is approximately equal to the length of the predetermined overhang.

5. The clip of claim 3, wherein the distance between the first stationary member and the second stationary member minus the thickness of cabinet wall is approximately equal to the length of the predetermined overhang.

6. The clip of claim 1, further comprising a base, wherein the cabinet wall receiving portion extends from the base in a first direction and the template receiving portion extends from the base in a second direction generally opposite the first direction.

7. The clip of claim 6, wherein the cabinet wall receiving portion comprises a flexible arm having a first end attached to the base and a second end spaced apart from the base, the flexible arm extending away from the base from the first end to an intermediate portion and toward the base from the intermediate portion to a second end from the base to an intermediate portion and toward the base from the intermediate portion to the second end.

8. The clip of claim 7, wherein the flexible arm is substantially V-shaped.

9. The clip of claim 1, wherein the length of the predetermined overhang is approximately zero.

10. The clip of claim 1, further comprising an electronic template target element removably coupleable to the template receiving portion.

11. A countertop template clip for positioning a template piece relative to a cabinet wall, comprising:
a base extending from a first end portion to a second end portion;
a cabinet wall securing portion coupled to the base and comprising (i) a resiliently flexible first arm having a first portion attached to and extending away from the base and a second portion extending from the first portion toward the first end portion of the base, and (ii) a second arm extending approximately parallel to the first portion of the first arm and away from the base at a location between the second portion of the first arm and the first end portion of the base; and
a template securing portion coupled to the base and comprising a resiliently flexible third arm having (i) a first portion attached to and extending away from the base in a direction substantially opposite the first portion of the first arm, and (ii) a second portion extending from the first portion toward the second end portion of the base.

12. The clip of claim 11, wherein the second arm of the cabinet wall securing portion is intermediate the resiliently flexible first arm and the first portion of the resiliently flexible third arm.

13. The clip of claim 11, wherein a distance between the second arm of the cabinet wall securing portion and the first portion of the resiliently flexible third arm is approximately equal to a predetermined overhang of the template piece relative to the cabinet wall.

14. The clip of claim 13, wherein the predetermined overhang is approximately zero.

15. The clip of claim 11, wherein the resiliently flexible first arm is movable away from the second arm to removably secure a cabinet wall between the first arm and the second arm, and wherein the resiliently flexible third arm is movable away from the base to removably secure a template piece between the first arm and the base.

16. The clip of claim 15, wherein the cabinet wall has an outer surface and an inner surface, and wherein when removably secured between first arm and the second arm, the first arm is in contact with the inner surface and the second arm is in contact with the outer surface.

17. The clip of claim 11, wherein a minimum distance between the second portion of the first arm and the second arm is less than a thickness of the cabinet wall, and wherein a minimum distance between the second portion of the third arm and the base is less than a thickness of the template piece.

18. The clip of claim 11, wherein the base and template securing portion cooperatively provide a substantially arcuate clip.

19. The clip of claim 11, wherein the first arm, second arm, and base cooperatively form an internally spring-biased clip.

20. A method of positioning a countertop template piece at a desired overhang relative to a cabinet wall, comprising:
providing a countertop template tool comprising a cabinet wall receiving portion having a first resiliently flexible member and a first stop and a template piece receiving portion having a second resiliently flexible member and a second stop, the first stop and second stop being a predetermined distance apart;
removably securing a cabinet wall within the cabinet wall receiving portion by resiliently flexing the first resiliently flexible member with the cabinet wall;
positioning the cabinet wall in contact with the first stop;
removably securing a template piece within the template piece receiving portion by resiliently flexing the second resiliently flexible member with the template piece; and
positioning an outer edge of the template piece in contact with the second stop.

21. The method of claim 20, wherein the predetermined distance equal to the desired overhang.

22. The method of claim 20, wherein the predetermined distance minus a thickness of the cabinet wall is equal to the desired overhang.

23. The method of claim 20, wherein the first resiliently flexible member applies a biasing force to the cabinet wall to removably secure the cabinet wall within the cabinet wall receiving portion and the second resiliently flexible member applies a biasing force to the template piece to removably secure the template piece within the template piece receiving portion.

24. An electronic countertop template clip, comprising:
a cabinet wall receiving portion removably engageable with a cabinet wall; and
an electronic countertop template target portion coupled to the cabinet wall receiving portion and comprising a target;
wherein, when the cabinet wall receiving portion is removably engaged with a cabinet wall, the target is positioned at a predetermined overhang distance away from an outer surface of the cabinet wall.
